(19) United States
(12) Patent Application Publication
(10) Pub. No.: US 2007/0176374 A1
(43) Pub. Date: Aug. 2, 2007

(54) Tool chuck for use with a rotating machine

(75) Inventor: Yves Cachod, Levier (FR)

Correspondence Address: OLIFF & BERRIDGE, PLC, P.O. BOX 19928, ALEXANDRIA, VA, 22320, US

(73) Assignee: ETABLISSEMENTS AMYOT S.A., PONTARLIER (FR)

(21) Appl. No.: 11/699,027

(22) Filed: Jan. 29, 2007

(30) Foreign Application Priority Data
Feb. 2, 2006 (FR) 06/00958

(51) Int. Cl. B23B 31/12

(52) U.S. Cl. 279/62

(57) ABSTRACT

The central component of the chuck supports jaws that can be moved between a tool clamping position and a released position.

Each jaw comprises a seat that is open towards the axis and has a back and lateral faces.

A roller is fitted against the back of the seat and is rotatable about its axis parallel to the axis and translationally movable between the two lateral faces of the seat.

The back of the seat forms a very flat V, in the center of which the roller positions itself when an operator tightens the jaws on the tool. Then, when the chuck is rotated, to the right, the roller rolls without sliding on the jaw and on the tool until it is wedged against the straight lateral face of the seat. Excellent clamping of the tool is thus obtained.

The present invention relates to a tool chuck for use with a rotating machine.

### BACKGROUND OF THE INVENTION

The function of a chuck mounted on the shaft of a rotating machine is to grip a tool, such as a bit in the case of a drilling tool. The tool is often gripped in the chuck by three jaws that converge in the forward direction and are moved and guided by various means provided inside the chuck, in such a way that if the jaws are moved forwards they will also move towards each other and so clamp the tool, whereas if the jaws are moved backwards they will also release the tool. This sort of chuck is generally fitted with a central component that possesses both a rear part designed to be attached to the rotating machine, and a front part to which the jaws are connected.

Some more elaborate chucks are fitted with carbide inserts brazed onto the jaws to form the part of the jaw which is in contact with the shank of the tool when the shank is mounted in the chuck. The purpose of these carbide inserts is essentially to give the jaws excellent resistance to wear, but also to enable the jaws to bite into the tool shank to increase the clamping power of the chuck and thus ensure that the tool cannot rotate inside the chuck. The main problem with these carbide inserts is that they result in very rapid damage to the tool shank.

Very often, drill chucks of this kind also have the feature of being hand-tightened chucks, meaning that they do not need a key to tighten them. One of the most important issues with these chucks is the tightening torque which they are capable of developing. For obvious reasons of flexibility of use, these chucks must develop the greatest possible tightening torque on the tool and the operator must exert the least possible tightening effort on the chuck. In other words the efficiency of the chuck must be as great as possible in order to satisfy the requirements of the market as well as possible.

### DESCRIPTION OF THE PRIOR ART

For example, the prior art includes chucks of the type with jaws sliding in bores formed in the central body part and converging in the forward direction. The jaws are threaded on their outward face and engage with the threaded inward face of a nut which in turn engages with the inside wall of a collar mounted rotatably on the body.

In this case, the rotational movement of the nut (via the collar) causes a translational movement of the jaws. This system therefore converts a tightening torque Ca applied to the nut into a normal effort Fn applied by the edge of the jaw to the tool shank. The intrinsic efficiency of the nut/jaw system determines the maximum normal effort Fn, which is a function of Ca: Fn=f(Ca).

The coefficient of friction u between the edge of the jaw and the tool shank decides the maximum value of the resultant tangential effort Ft, hence the resultant maximum torque Cr developed by the chuck:

Cr=R×Ft=R×Fn×u=R×f(Ca)×u

where r is the radius of the tool shank.

The efficiency of the chuck is therefore very closely related to the coefficient of friction u between the edge of the jaw and the tool shank, as well as to the torque Ca applied by the operator to the nut.

Thus, depending on the nature of the tool shank (hardness, roughness), the coefficient of friction can vary very greatly. As a result, the tightening torque developed by the chuck is highly random.

Again, document WO 01/81046 describes a system for tightening a shaft by means of rollers in contact with a cam wall. However, this system cannot be used to clamp shafts of all diameters. Besides, the tightening obtained is not altogether satisfactory because the rollers are retained against the cams by means of a single elastic cage connecting them all to each other: this makes the movements of the rollers interdependent and does not sufficiently solve the problems of shaft centering. Moreover, the curved and continuous profile of the cams does not guarantee precise positioning of the rollers against these cams. This is detrimental to the quality of the tightening.

It is an object of the present invention to solve the problems set out above by providing a chuck that is capable of developing a high tightening power, yet without damaging the tool shank and without requiring a large tightening effort from the operator.

Another object of the invention is to give excellent tightening despite the constraints of resistance and eccentricity which are inherent in chucks.

### SUMMARY OF THE INVENTION

For this purpose the invention relates to a tool chuck for use with a rotating machine, comprising:
a central component having an axis and comprising a rear part designed to be fixed to a drive shaft of the rotating machine and a front part to which are connected a number of jaws each having a central longitudinal plane;
means for moving the jaws between a tool clamping position and a release position;
a seat formed on the inward side of each jaw, said seat comprising an opening turned towards the axis of the central component, a back behind the opening, and, approximately parallel to the axis of the central component, first and second lateral faces; and
at least one roller mounted in and approximately against the back of each seat with the aid of a rigid retaining member separated from the retaining member of each of the other jaws, the roller being rotatable about its axis which is approximately parallel to the axis of the central component, and movable translationally between the two lateral faces of the seat, the distance between which faces is greater than the diameter of the roller, and the roller being capable of acting on the jaw and on the tool;
the back of which seat has two bearing portions, a first and a second, extending from the first lateral face and second lateral face, respectively, to the central longitudinal plane of the jaw, each bearing portion being curved or inclined transversely in such a way that the distance between the axis of the central component and said bearing portion increases with proximity to the central longitudinal plane, said bearing portions being adjacent and symmetrical about the central longitudinal plane and, where they meet, forming a roller positioning cavity so that when the tool is placed between the jaws the roller positions itself in contact with the back of the seat, essentially in the positioning cavity.

In practice, when clamping a tool in the chuck of the invention, three main sequences may be distinguished:
first phase: since the rollers are free in their seats, they adopt any position between the two lateral faces of the seat, in contact with the retaining member, or in contact with the bearing portions, or even in contact with one of the lateral faces; when the tool to be clamped contacts the rollers, the degree of mobility permitted to the roller by the retaining member and the particular geometry of the bearing portions allow the roller to move naturally in all cases into the center of the seat; the rollers of all the jaws will therefore arrive in a precise position centered on the central plane of each jaw, in the positioning cavity; the very geometry of the back of the seat, forming a sink or wedge into which the roller will naturally move when no rotational effort is being applied by the tool, when the operator is tightening the jaws, ensures an excellent positioning of the roller;
it should be observed that this structure avoids the use of a spring component for positioning the roller; the lateral faces limit the degree of sideways mobility of the rollers so as to make certain that the roller centers itself automatically during this phase;
second phase: the user finishes tightening the chuck; the rollers are in their central positions and the tightening effort applied by the user to the chuck generates contact forces between each roller, the back of the jaw seat, and the tool; in this configuration the bearing zones where the rollers bear on the tool are equally distributed around the tool (at 120° in the case of three jaws), which ensures the eccentricity of the chuck (conventional wobble tolerances for a tool mounted in the chuck); furthermore, the rollers are now in an ideal “uphill” position relative to each of the bearing portions;
third phase: being now set up in this way, the chuck will produce the desired wedge action as soon as the resistive torque exerted by the tool forces the rollers to roll across the bearing portions in either direction (left or right); it should be observed that during this phase the rollers may have no contact with the lateral faces of the seat: this is because the roller may position itself between one of the bearing portions and the shank of the tool to produce the wedge action.

When operated in the appropriate direction of rotation, the resistive torque exerted by the tool causes the roller to move towards one lateral wall by rolling without sliding over the tool and over the jaw, resulting in good transmission of the rotational movement between the jaw (driven by the rotating machine) and the tool. Owing to the curvature or inclination of the bearing portion of the back of the seat across which the roller is moving, the roller moves closer to the axis of the central component, and hence of the tool, until the wedge action is produced (not necessarily in contact with said lateral wall). The invention achieves a wedging of the roller and excellent tool clamping when in operation, even if the initial clamping by the operator is not very great. Moreover, because the back of the seat is symmetrical, the tool will be clamped very securely in either direction of rotation of the central head.

Consequently the chuck of the invention makes the clamping power of the chuck almost totally independent of:
the tightening torque Ca applied to the nut, and therefore independent of the intrinsic efficiency of the chuck;
and of the coefficient of friction u between the jaw and the shank of the tool.

In one possible embodiment of the chuck, viewed in a transverse plane, at every point of the first bearing portion the angle (α) formed between the tangent to the first portion at said point and the tangent to the roller passing through the point of contact between the roller and the tool when the roller is against the first lateral face of the seat is such that:

tan α/2<Umin
where Umin is the lesser of the following values:
   the coefficients of friction u between the roller and a tool selected from a predetermined set of tools that may be held in the chuck;
   and the coefficient of friction u′ between the roller and the jaw.

Thus, if a set of tools that may be held in the chuck are identified on the one hand, and if the values of the corresponding coefficients of friction u are known, and if the coefficient of friction u′ between the roller and the jaw is known on the other hand, then is certain that tan α/2<u′ and tan α/2<u for each of the tools of the set considered. This relation ensures that the roller will roll over the tool and over the jaw without sliding when the roller reaches the first lateral face of the seat or, more generally, when the roller is wedged in an extreme position (which may not necessarily be against this lateral face).

For example, the first bearing portion is essentially planar and parallel to the axis of the central component and, viewed in a transverse plane, the angle (α) formed between the first bearing portion and the tangent to the roller passing through the point of contact between the roller and the tool when the roller is against the first lateral face of the seat is such that:

tan α/2<Umin.

The angle (α) may be between 0.5 and 2°, and for example about 1°.

In an advantageous embodiment, the first and second bearing portions basically form, where they meet, an obtuse angle of between 165° and 175°. It is in this angle that the roller will position itself.

For example, the seat is formed longitudinally in the jaw and the retaining member is fitted in the opening of the seat of said jaw to retain the roller in said seat while allowing it to move rotationally and translationally, a slot being provided in said retaining member to allow the roller to partially project out of the seat and contact the tool.

The roller may be essentially cylindrical and may have at each end an axial rod able to engage in a part of the retaining member that borders the slot.

### BRIEF DESCRIPTION OF THE DRAWINGS

Two possible embodiments of the invention will now be described by way of nonrestrictive examples with reference to the attached drawings:

FIG. 1 is an exploded perspective view of a chuck in accordance with the invention;

FIG. 2 is a side view of the chuck seen in FIG. 1, in the assembled position, and holding a tool;

FIGS. 3, 4 and 5 are perspective views of a jaw, a roller and a retaining member, respectively, for use with the chuck seen in FIG. 1;

FIG. 6 is a front view of the jaw of FIG. 3 containing the roller and retaining member;

FIG. 7 is a cross section through the jaw taken on the line marked AA in FIG. 6;

FIG. 8 is a cross section through the chuck taken on the line marked A′A′ in FIG. 2, before the chuck is spun;

FIG. 9 is an enlarged view of detail B marked in FIG. 8;

FIGS. 10 and 11 are similar views to FIGS. 8 and 9 when the chuck is turning to the right;

FIG. 12 is a view similar to FIG. 11 when the chuck is turning to the left; and

FIG. 13 is a diagrammatic view of the tool, the jaw and the roller with the normal and tangential forces acting on the roller.

### DESCRIPTION OF THE PREFERRED EMBODIMENTS

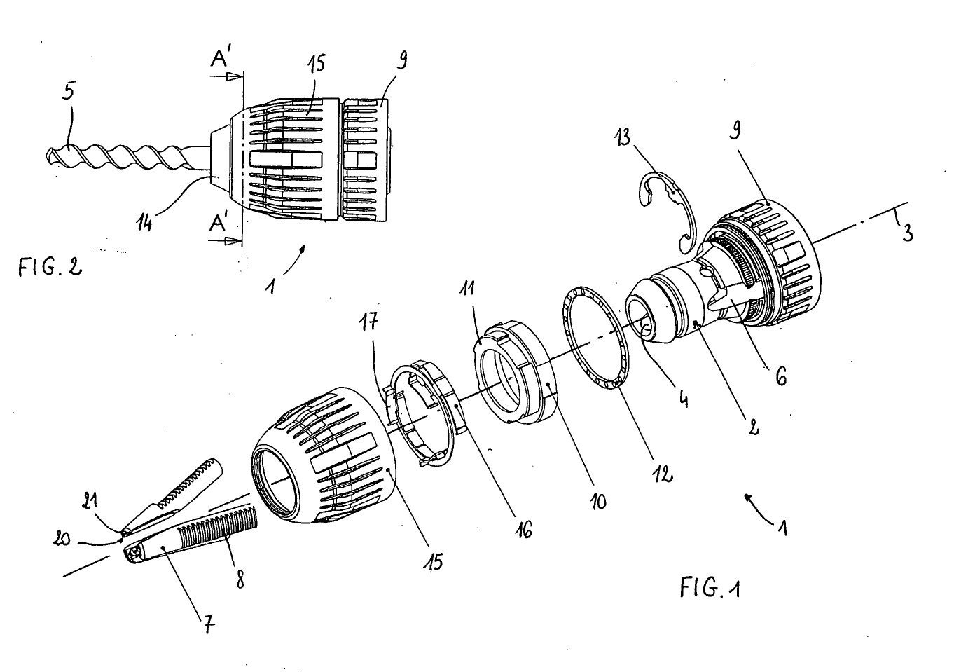

FIGS. 1 and 2 will be considered first.

The chuck 1 comprises a central component forming in this case a body 2, the general shape of which is cylindrical, of axis 3. The rear part of the body 2 comprises an orifice for the insertion of the spindle of a rotating machine such as a drill. The front part of the body 2 comprises a longitudinal bore for inserting a tool 5 such as a drill bit, and three seats 6 converging in the forward direction, each accommodating a jaw 7 and guiding it as it moves translationally. The jaws 7 have an external thread 8.

The chuck 1 also includes a basically cylindrical rear ring 9 engaged essentially coaxially around the rear part of the body 2, to which it is attached in any suitable way.

A nut 10 is engaged around the jaws 7, essentially coaxially to the body 2. The nut 10 has an internal thread engaging with the external thread 8 of the jaws 7 to move the jaws 7 towards the clamping or released position depending on the direction in which the nut 10 is rotated. The nut 10 also includes three approximately radial teeth 11 distributed at equal intervals around its periphery. The nut 10 is installed against the rear of the body 2. To facilitate its rotation, a ball-bearing cage 12, held in place by a circlip 13, is inserted between the nut 10 and the body 2. A metal nose 14 is also installed on the body 2 in front of the nut 10 to keep the nut 10 in its axial position.

The chuck 1 also includes a basically cylindrical tightening ring 15 (or collar) mounted essentially coaxially around the nut 10 and prevented from rotating by the rear ring 9 behind and by the metal nose 14 in front.

Between the ring 15 and the nut 10 is a spring 16 having three members 17 projecting in towards the axis 3 and designed to be inserted between the teeth 11 of the nut 10, so that when an operator turns the ring 15, the nut 10 is also turned and therefore the jaws 7 are moved.

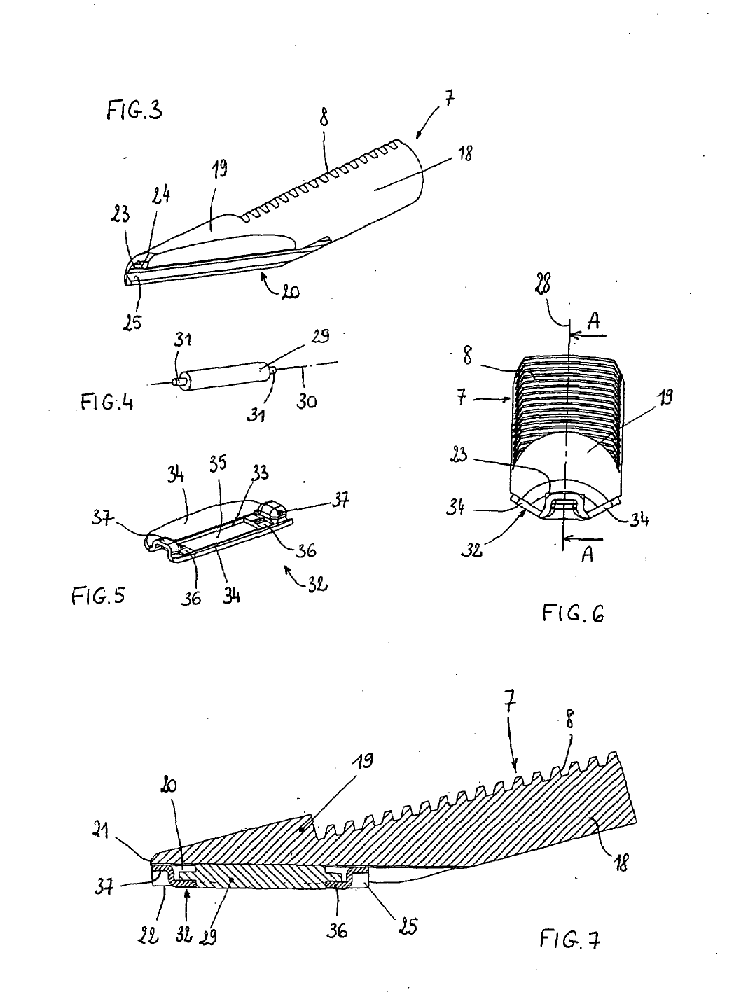

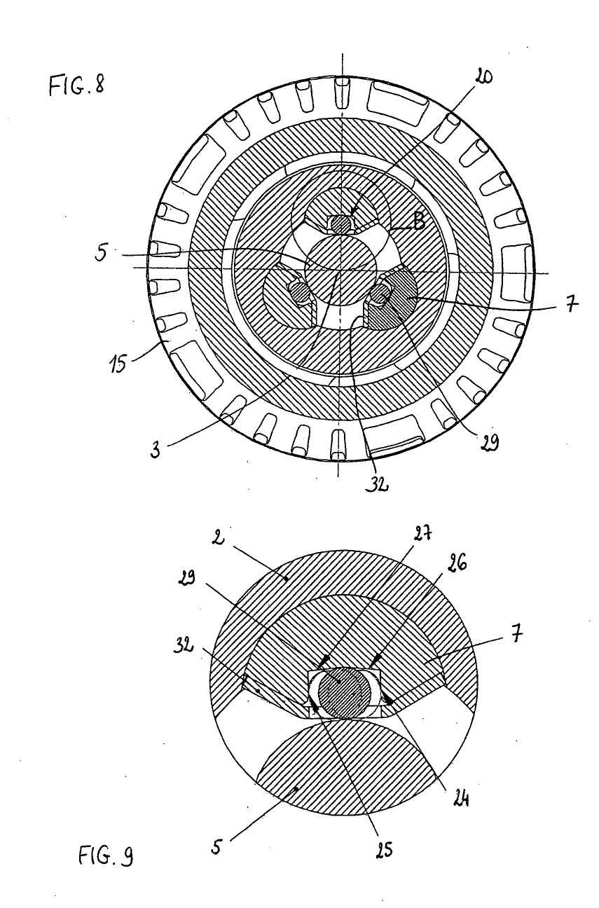

As illustrated in FIGS. 3 and 7, each jaw 7 comprises a rear part 18 inclined with respect to the axis 3 and sliding in a seat 6 in the body 2, and a front part 19 whose inward face, that is the face turned towards the axis 3, is essentially parallel to the axis 3 and designed to come into contact with the tool 5.

Each jaw 7 comprises a seat 20 formed in its front part 19, on the inward side. The seat 20 extends longitudinally from the front end 21 of the jaw 7 to the angle formed between the front part 19 and rear part 18. The seat 20 comprises an opening 22 facing towards the axis 3, a back 23 behind the opening 22, and first and second lateral faces 24, 25. The lateral faces 24, 25 are essentially parallel to the axis 3, parallel to each other, and basically perpendicular to the inward face of the front part 19 of the jaw 7.

The back 23 of the seat 20 comprises a first bearing portion 26 adjacent to the first lateral face 24, and a second bearing portion 27 adjacent to the second lateral face 25 and to the first bearing portion 26. The two bearing portions 26, 27 are symmetrical about the central longitudinal plane 28 of the jaw 7.

The first bearing portion 26 is in the form of a slightly inclined plane: when viewed in a plane lying transversely relative to the axis 3, the distance between this plane and the axis 3 decreases with proximity to the first lateral face 24 and increases with proximity to the second lateral face 25. Similarly the second bearing portion 27 is therefore in the form of a slightly inclined plane: when viewed in a plane lying transversely relative to the axis 3, the distance between this plane and the axis 3 decreases with proximity to the second lateral face 25 and increases with proximity to the first lateral face 24. The back 23 of the seat 20 is thus in the form of a very flattened V (see FIG. 9).

An essentially cylindrical roller 29 is placed in the seat 20 with its axis 30 essentially parallel to the axis 3. The roller 29 has an axial rod 31 at each end.

The diameter of the roller 29 is slightly greater than the depth of the seat 20 so that when the roller 29 is in contact with the back 23 of the seat 20, even in the angle between the bearing portions 26, 27 of the back 23, the roller 29 projects beyond the lower face of the front part 19 of the jaw 7.

A retaining member 32 is fitted in the opening 22 of the seat 20 of the jaw 7 to retain the roller in the seat 20. The retaining member 32 comprises an essentially rectangular central part 33 designed to be placed in the opening 22, and two lateral wings 34 fixed to the lower face of the front part 19 of the jaw 7. The central part 33 contains an essentially rectangular slot 35 whose length (along the axis 3) is approximately the same as the length of the roller 29 and whose width (transversely) is greater than the diameter of the roller 29. Borders 36 support the rods 31 of the roller 29 to the front and rear of the slot 35. Lastly, protuberances 37 at the longitudinal ends of the retaining member 32 close the seat 20.

When the roller 29 is assembled in the seat 20 closed by the retaining member 32, the roller 29 is engaged in the slot 35. The roller 29 is thus in contact with the back 23 of the seat 20 while projecting slightly from the lower plane of the front part 19 of the jaw 7. At the same time, the roller 29 is prevented from making any significant longitudinal movement. On the other hand, the roller 29 is able to rotate on its axis 30 and at the same time to move translationally between the two lateral faces 24, 25 of the seat 20, moving approximately at right angles to said lateral faces 24, 25. These movements are not obstructed by the retaining member 32.

The angle of inclination of the bearing portions 26, 27 of the back 23 of the seat 20 is defined as follows: when the roller 29 is in contact with the first lateral face 24 of the seat 20 and a tool 5 is inserted into the chuck 1 (FIG. 13), the tangent T to the roller 29 passing through the point of contact P between the roller 29 and the tool 5 forms an angle α with the first bearing portion 26, when viewed in a transverse plane.

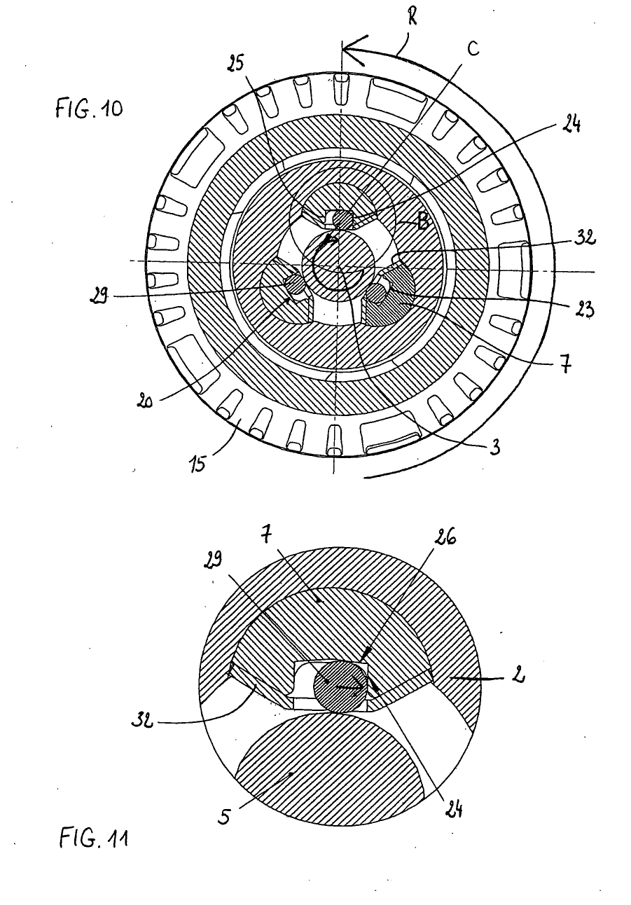

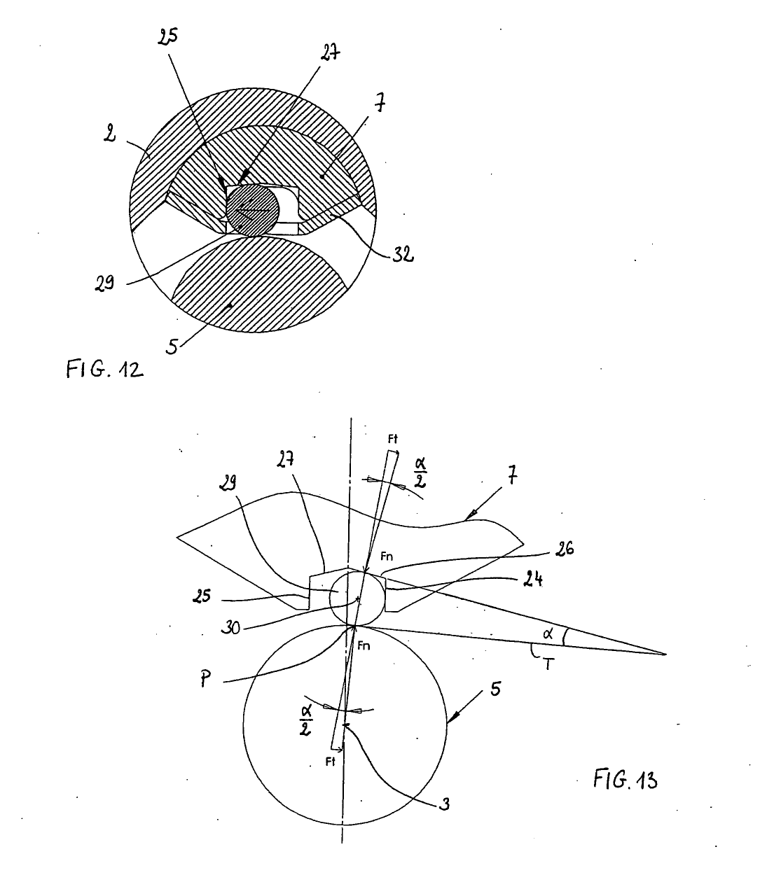

The operation of the chuck will now be described with reference to FIGS. 8 to 12.

When the chuck 1 is open, the roller 29 is free to lie at random in the seat 20 of the jaw 7. As the chuck 1 closes, the roller 29 makes contact with the tool 5 shank. The bearing portions 26, 27 angled towards each other at a V now force the roller 29 to shift naturally into its central position in the seat 20, as illustrated in FIGS. 8 and 9. In this position of stable equilibrium, the effort Fn can now be applied by the jaw 7 to the roller 29.

When the chuck 1 is operating in rotation R to the right (FIG. 10), the torque applied by the machine and the resistive torque C applied by the tool 5 to the roller 29 force the latter to leave its central position of equilibrium and move across the right-hand portion of the back 23—in this case the first bearing portion 26—towards the right-hand lateral face of the seat 20, in this case the first lateral face 24. This means that the roller 29 is now closer to the axis 3 and therefore tends to clamp the tool 5. It should be observed that the wedge action can be produced even if the roller 29 is not in contact with this lateral face of the seat 20.

In order for the desired wedge action to be effective, the roller 29 must roll without sliding on the jaw and on the tool. This means that, at the points of contact of the roller 29 with the jaw 7 and with the tool 5, the following relation must be satisfied: Ft/Fn<u, where:
u is the coefficient of friction between the roller and the component of interest (tool 5 or jaw 7);
Ft is the tangential effort;
Fn is the normal effort.

Because of the geometry of the chuck 1, and specifically of the jaws 7, the angle between Ft and Fn is α/2 (see FIG. 13). It is therefore sufficient for the coefficient of friction u between the jaw 7, the roller 29 and the tool 5 shank to be greater than the tangent of the angle α/2: u>tan α/2. If the values of u are known for different tools and for the jaw and roller, it is a very simple matter to satisfy this relation by selecting an appropriate value for α.

An angle α of the order of 1° gives good results in terms of wedging and clamping. It also gives a back 23 of the seat 20 that is neither too flat (which would mean that the roller would not position itself spontaneously in the center), nor too closed (in which case the roller would have a tendency to remain in the central position).

With the invention, the resulting effort on the roller 29 presses the latter between the first bearing portion 26 and the tool 5 shank. The wedge action thus produced between the jaw, the roller and the tool shank clamps the tool 5 completely in the chuck 1, and this independently of the intrinsic efficiency of the chuck and of the coefficient of friction u.

Rotation of the ring 15, resulting in rotation of the nut 10, is used only to adapt the clamping diameter of the chuck 1 to the diameter of the tool 5 shank. The normal effort Fn required of this system on the roller 29 is very small, compared with the traditional system. It merely ensures that the roller 29 is in good contact with the jaw 7 and tool 5 shank and that it can roll without sliding against the bearing portions 26, 27 of the seat 20 back 23 and against the tool 5 shank, forming a wedge angle.

The invention thus makes it possible to generate a very large tightening torque, without furthermore damaging the shank of the tool.

When the chuck 1 is working in rotation to the left (FIG. 12), the phenomenon described above is produced in the same way, symmetrically with respect to the central longitudinal plane 28 of the jaw 7. The roller 29 thus makes contact with the second lateral face 25 (the left-hand lateral face) after rolling without sliding across the second bearing portion 27 and across the tool 5. The wedge action can also be produced if the roller is not in contact with the second lateral face 25.

In the description given above, only one roller is placed in each seat. It is however possible to have several rollers in one seat.

It goes without saying that the invention is not limited to the embodiments described above by way of examples but that on the contrary it encompasses all alternative embodiments.

In particular, the invention could be applied to other types of chuck, such as:
a chuck in which the jaws are guided in translation in seats formed in a body rotating about the central component so as to move the jaws in order to clamp or release the tool, the jaws having a thread on their inward face engaging with a thread on the forward part of the central component;
a chuck in which the jaws are urged forwards by an elastic member and in which an operator moves the jaws back by a translational action on an appropriate member, when inserting the tool.

1. A tool chuck for use with a rotating machine, comprising:
a central component having an axis and comprising a rear part designed to be fixed to a drive shaft of the rotating machine and a front part to which are connected a number of jaws each having a central longitudinal plane; and
means for moving the jaws between a tool clamping position and a release position;
which chuck comprises
a seat formed on the inward side of each jaw, said seat comprising an opening turned towards the axis of the central component, a back behind the opening, and, approximately parallel to the axis of the central component, first and second lateral faces; and
at least one roller mounted in and approximately against the back of each seat with the aid of a rigid retaining member separated from the retaining member of each of the other jaws, the roller being rotatable about its axis which is approximately parallel to the axis of the central component, and movable translationally between the two lateral faces of the seat, the distance between which faces is greater than the diameter of the roller, and the roller being capable of acting on the jaw and on the tool;
the back of which seat has two bearing portions, a first and a second, extending from the first lateral face and second lateral face, respectively, to the central longitudinal plane of the jaw, each bearing portion being curved or inclined transversely in such a way that the distance between the axis of the central component and said bearing portion increases with proximity to the central longitudinal plane, said bearing portions being adjacent and symmetrical about the central longitudinal plane and, where they meet, forming a roller positioning cavity so that when the tool is placed between the jaws the roller positions itself in contact with the back of the seat, essentially in the positioning cavity.

2. The chuck as claimed in claim 1, wherein, viewed in a transverse plane, at every point of the first bearing portion the angle (α) formed between the tangent to the first bearing portion at said point and the tangent to the roller passing through the point of contact between the roller and the tool when the roller is against the first lateral face of the seat is such that: tan α/2<Umin
where Umin is the lesser of the following values:
the coefficients of friction u between the roller and a tool selected from a predetermined set of tools that may be held in the chuck;
and the coefficient of friction u′ between the roller and the jaw.

3. The chuck as claimed in claim 1, wherein the first bearing portion is essentially planar and parallel to the axis of the central component and wherein, viewed in a transverse plane, the angle (α) formed between the first bearing portion and the tangent to the roller passing through the point of contact between the roller and the tool when the roller is against the first lateral face of the seat is such that: tan α/2<Umin
where Umin is the lesser of the following values:
the coefficients of friction u between the roller and a tool selected from a predetermined set of tools that may be held in the chuck;
and the coefficient of friction u′ between the roller and the jaw.

4. The chuck as claimed in claim 2, wherein the angle (α) is between 0.5 and 2°.

5. The chuck as claimed in claim 1, wherein the first and second bearing portions basically form, where they meet, an obtuse angle of between 165° and 175°.

6. The chuck as claimed in claim 1, wherein the seat is formed longitudinally in the jaw and in that the retaining member is fitted in the opening of the seat of said jaw to retain the roller in said seat while allowing it to move rotationally and translationally, a slot being provided in said retaining member to allow the roller to partially project out of the seat and contact the tool.

7. The chuck as claimed in claim 6, wherein the roller is essentially cylindrical and at each end has an axial rod able to engage in a part of the retaining member that borders the slot.

8. The chuck as claimed in claim 1, wherein the jaws are guided in translation in seats formed in the central body component, said jaws converging towards the front and having a thread on their outward face, and in that the chuck comprises a nut placed around the central component and having an internal thread engaging with the thread of the jaws so that the jaws can be moved in order to clamp or release the tool.

9. The chuck as claimed in claim 1, wherein the jaws are guided in translation in seats formed in a body rotating about the central component so as to move the jaws in order to clamp or release the tool, the jaws having a thread on their inward face engaging with a thread on the forward part of the central component.
